(19) United States
(12) Patent Application Publication
(10) Pub. No.: US 2008/0210839 A1
(43) Pub. Date: Sep. 4, 2008

(54) SMOKE DETECTOR RECESSED BOX

(76) Inventor: Charles R. Klapp, Harrison Township, MI (US)

Correspondence Address: CARGILL & ASSOCIATES, P.L.L.C., 56 MACOMB PLACE, MT. CLEMENS, MI, 48043, US

(21) Appl. No.: 11/940,985

(22) Filed: Nov. 15, 2007

Related U.S. Application Data
(60) Provisional application No. 60/865,885, filed on Nov. 15, 2006.

(51) Int. Cl. G08B 21/16

(52) U.S. Cl. 248/343

(57) ABSTRACT

Disclosed is a flush mountable housing that is an effective and inexpensive smoke detector recessed box for receiving and recessing a conventional smoke detector while still allowing for perfect functionality. Specific air passageways are disclosed for trapping the smoke and gases in order to provide for the smoke detector to make an earlier detection than if the smoke detector was mounted conventionally and protruded from the ceiling.

### BACKGROUND OF THE INVENTION

1. Field of the Invention

This invention relates generally to a smoke detector and more particularly relates to a smoke detector recessed box for flush mount installing a smoke detector into a ceiling so that when installed, the smoke detector does not substantially protrude from the ceiling.

2. Description of the Prior Art

New home construction and remodeling have nearly become a national pastime. Television shows and entire television network channels are devoted to remodeling and new construction. It seems that everyone wants to beautify their home. In that regard, conventional smoke detectors have to be installed after tens of thousands of dollars are used to beautify a room. These smoke detectors appear to be very utilitarian, and are deemed to be unattractive in their appearance once they have been installed. However, everyone wants to have a safe home.

An unobtrusive smoke detector would be desirable so long as it fully functions. Functionality is paramount to a homeowner, but appearance comes in at a close second. It would be desirable to have an unobtrusive smoke detector that still provided all the functions of a traditional ceiling mounted smoke detector. Conventional smoke detectors are well known in the art. The smoke detector described in this application is defined as an active fire protection device that detects airborne smoke and issues an audible alarm, thereby alerting nearby people to the danger of fire. Various smoke detectors may be used, such as a fire detector, fire alarm, thermal sensor, an ionization detector, carbon monoxide detector, photoelectric detector, activator and the like.

Most smoke detectors work either by optical detection or by ionization, but some of them use both detection methods to increase sensitivity to smoke. Smoke detectors may operate alone, be interconnected to cause all detectors in the premises to sound an alarm if one is triggered, or be integrated into a fire alarm or security system. Smoke detectors with a visual alarm, such as flashing lights, are available for the deaf or hearing impaired.

Smoke detectors are most commonly attached to inner surfaces of buildings such as walls and ceilings. Since smoke and hot air trigger the alarm sounding off, and since smoke and hot air rise, the devices are preferably mounted up high, especially on the ceiling. Years ago, the first generation smoke alarms were hard wired directly into the building's power supply with an uninterruptable connection. Then, the second generation were cheaper and easier to install because they were battery powered and removably attached to allow changing of the battery. Many present building codes require that the devices have dual power sources such as the hard-wired connection as well as a battery for emergency power.

In modern construction, it is generally preferred, from an aesthetic viewpoint, for internal building surfaces to be free of obstructions and protrusions. To accomplish this goal, recessed lighting fixtures have been developed for both new construction and retrofitting. Such fixtures include recessed and indirect lighting appliances as well as recessed speakers.

A major disadvantage of conventional smoke detectors is their visual appearance. For example, FIG. 1 shows a prior art conventional smoke detector installed onto a ceiling board. Since it is attached to an interior surface, the smoke detector protrudes from the surface of the ceiling. This protrusion from the surface breaks the homogeneity of the surface and makes the smoke detector more apparent when other fixtures are recessed. Accordingly, there is a long-standing need for a recessed smoke detector.

### SUMMARY OF THE INVENTION

Therefore, the present invention provides a housing that is an effective and inexpensive smoke detector recessed box for receiving and recessing a conventional smoke detector while still allowing for perfect functionality. Specific air passageways are disclosed for trapping the smoke and gases in order to provide for the smoke detector to make an earlier detection than if the smoke detector was mounted conventionally and protruded from the ceiling. Besides that advantage, the smoke detector recessed box of the present invention provides various other advantages.

In a first advantageous aspect of the present invention, the smoke detector recessed box includes at least one power supply tab, which allows use of dual power smoke detectors. In a second, the smoke detector is removably attached to the smoke detector recessed box; therefore, it allows easy replacement of batteries and servicing. Third, the smoke detector recessed box does not cover the smoke detector, so the function of the smoke detector for detection of smoke is not compromised. Fourth, the present invention of the smoke detector recessed box maintains the insulation capabilities of the structure. And last, but not the least, this smoke detector recessed box is equally adaptable to both original construction and remodeling use.

### BRIEF DESCRIPTION OF THE DRAWINGS

For a further understanding of the nature and advantages of the expected scope and various embodiments of the present invention, reference shall be made to the following detailed description, and shall be taken in conjunction with the accompanying drawings, in which like parts are given the same reference numerals, and wherein:

FIG. 1 is a conventional smoke detector installed in the surface of a ceiling;

FIG. 2 is a cross-sectional view of a smoke detector recessed box installed in a ceiling, made in accordance with the present invention;

FIG. 3 is a bottom view of the smoke detector recessed box of FIG. 1; and

FIG. 4 shows the smoke detector recessed box with a smoke detector installed inside it in a ceiling surface.

### DETAILED DESCRIPTION OF THE INVENTION

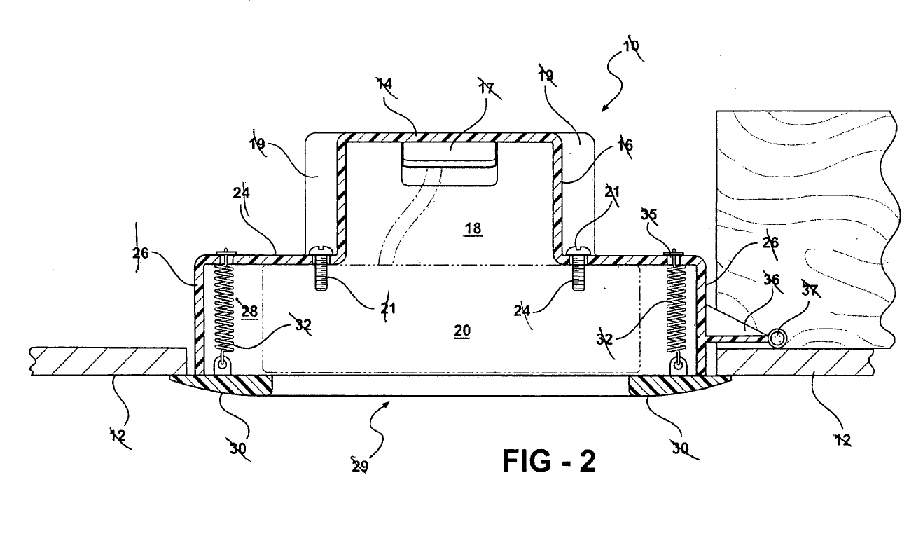

Referring now to the drawings in detail, FIG. 2 is a cross-sectional view of a smoke detector recessed box, generally indicated by the numeral 10, made in accordance with the present invention. The smoke detector recessed box 10 installed in a ceiling 12 includes a top wall 14 and first tier side walls 16, which define a first tier recessed area 18; and a flange 24 and second tier side walls 26, which define a second tier area 28 and an opening 29. The second tier recessed area 28 is sized sufficiently to collect rising hot air and smoke and will receive a conventional smoke detector 20 (shown in phantom) while the first tier area 18 is sized sufficiently to also collect smoke as well as to encompass at least one power supply tab 17 to provide the power connection for the smoke detector 20.

Power supply tab 17 provides the smoke detector 20 with a convenient place to receive a connection to a power supply from a building. Generally, a 110-volt supply line (not shown) from the building is connected to power supply tab 17, so that the smoke detector can be connected to the power supply tab 17 through a wire (not shown). When slowly connecting the wire of the smoke detector into the building power supply, the power supply tab 17 may snap into place, which indicates that the power supply is seated correctly and locked into position.

The smoke detector recessed box 10 further includes at least two recesses 19 in the first tier area 18 for mounting screws 21 or other attachment means to be inserted. Each recess 19 may include a cylindrical hole and screw thread on the inside of the cylindrical hole to allow the smoke detector 20 to be installed into the smoke detector recessed box 10. Although the present invention contemplates many different types of attachment means or fasteners, which are too numerous to mention, this description only describes mounting screws as an example. The scope of this invention shall not be so limited.

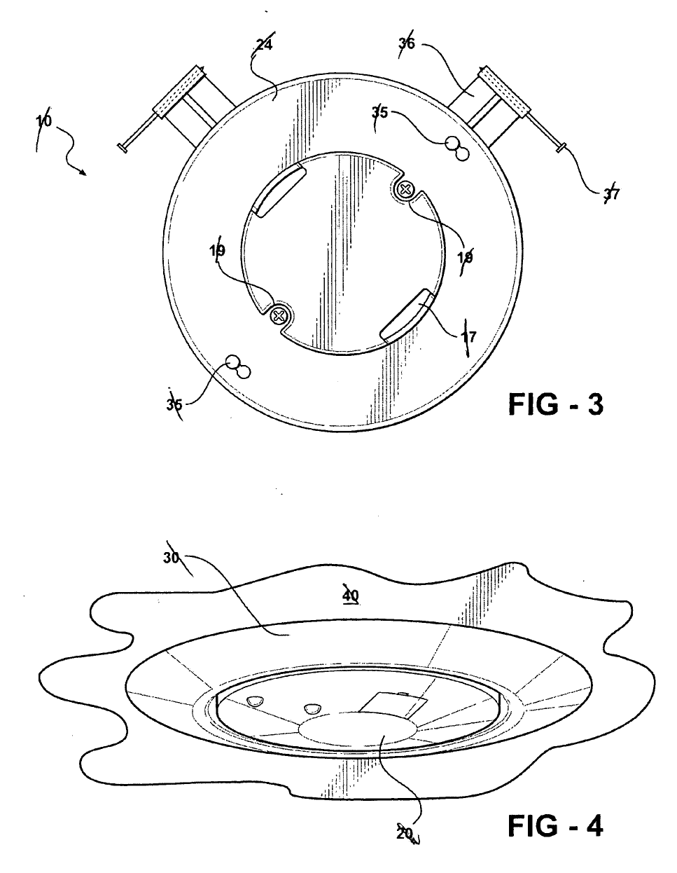

An annular trim ring 30 may be attached against the side walls 26 of the smoke detector recessed box 10 through spring mounts 32 to enable a flush mount of the smoke detector. Each spring mount 32 may be a coil spring with extended ends. One extended end of the spring mount 32 is attached to the flange 24 through a spring hole 35, as shown in FIG. 3, and the other extended end is attached to a spring mounting bracket (not shown) molded into the trim ring 30. In order to effect a flush mount aspect of the present invention, trim ring 30 may be made of any suitable material, such as plastic, metal, alloy, and wood. For different interior designs, the trim ring may be molded in different colors. Preferably, the trim ring is about 5″ to 7″ in diameter. When it is desired, the trim ring may be custom made for specific designs. After being attached to the smoke detector recessed box, trim ring 30 is substantially flush with the surface of the ceiling 12, but does not cover the smoke detector. Because the smoke detector is not covered, its function for detection of smoke is not compromised and it can be removed easily.

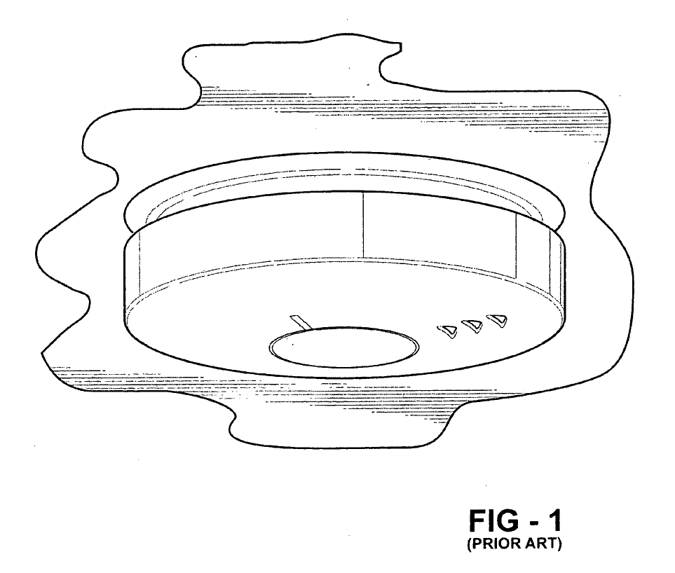

First and second tiered recessed areas 18 and 28 are sized to allow smoke to collect in areas adjacent to the sensors in any conventional smoke detector therein that are mounted within the flush mount. As these tiered recessed areas 18 and 28 are higher than the lowest part of ceiling 12, any smoke will tend to rise to the highest point in the room, which will be into first and second recessed areas 18 and 28. Once the gas and smoke enter recessed area 18 and flow upward into area 28, the entire smoke detector will be surrounded by air and gas, rather than conventional systems which only receive smoke and gas under the rim as can be seen in FIG. 1.

The additional air space provided by first and second tiered recessed areas 18 and 28 give a possibility of an earlier fire detection, thereby monitoring for smoke and fire at an earlier point in time than conventional smoke detectors. Due to this additional possible escape time, for example one to five minutes, a family would be alerted earlier to a fire in their home, and would be able to get out much earlier, thereby giving them precious extra minutes to exit from the home before they are injured.

With combined reference to FIG. 2 and FIG. 3, the recessed area into which smoke detector 20 is recessed into, i.e. the first and second tiered recessed areas 18 and 28, respectively, the upper and lower recessed areas provide more surface area for the gases to contact the sensor. As can be seen in FIG. 3, the entire central portion of the flush mount cap of the present invention provides a collection area for the smoke.

FIG. 3 is a bottom view of the flush mount smoke detector recessed box 10 of FIG. 2. Here, smoke detector recessed box 10 includes four power supply tabs 17, as an example, for power supply from the building. The power supply tabs 17 are convenient and can be easily connected to the electrical system of the building. The recesses 19 are located between power supply tabs 17 and face each other. Smoke detector recessed box 10 may further include a mounting flange for mounting the recessed box 10 in the ceiling. The mounting flange may be a nail flange 36 with a nail 37 as shown in FIG. 2 and FIG. 3. This convenient mounting flange of the present invention allows the invention to be installed into both new construction and a remodeled building.

The smoke detector recessed box may be made of various suitable materials. In various aspects of the present invention, suitable materials include plastic, metal, alloy, cardboard and ceramic. For plastic smoke detector recessed boxes, it is suitable for it to be made from an injection molding process. Since the prior art conventional smoke detector has a standard size of about five inches in diameter, the smoke detector recessed box may also be made in a single size, which suits nearly every conventional smoke detector. However, for special designs, the smoke detector recessed box may be made differently for special accommodation. It is also envisioned by the inventor that the smoke detector may be designed in different sizes and shapes, as long as it allows full function of the smoke detector power supply wiring from the building and it can accommodate a smoke detector.

FIG. 4 shows the smoke detector 20 installed inside the smoke detector recessed box in a ceiling surface 40. The smoke detector 20 and the trim ring 30 are substantially flush with the surface of the ceiling. While the trim ring 30 does not cover the smoke detector 20, the smoke detector 20 is removably attached to the smoke detector recessed box to allow easy replacement of batteries and servicing. In addition, the function of smoke detector 20 for detection of smoke is not compromised by the use of this smoke detector recessed box and is quite possibly even enhanced by the present design. The gap between the smoke detector 20 and the trim ring 30 is limited; therefore, the smoke detector recessed box of the present invention maintains the insulation capabilities of the structure.

In summary, numerous benefits have been described which result from employing any or all of the concepts and the features of the various specific embodiments of the present invention, or those that are within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated.

What is claimed is:

1. A smoke detector recessed box for receiving and recessing a conventional smoke detector while still allowing for functionality, comprising:
a flush mounted housing sized to accommodate a conventional smoke detector, such that said housing is adapted to be mounted conventionally and protruded from the ceiling.
